(19) United States
(12) Patent Application Publication
(10) Pub. No.: US 2015/0253507 A1
(43) Pub. Date: Sep. 10, 2015

(54) OPTICAL MEMBER AND COUPLING OPTICAL SYSTEM

(71) Applicant: Konica Minolta, Inc., Tokyo (JP)

(72) Inventor: Akiko Hara, Hachioji-shi (JP)

(73) Assignee: Konica Minolta, Inc., Tokyo (JP)

(21) Appl. No.: 14/433,960

(22) PCT Filed: Sep. 25, 2013
(86) PCT No.: PCT/JP2013/075889

§ 371 Date: Apr. 7, 2015

(30) Foreign Application Priority Data
Oct. 24, 2012 (JP) 2012-234697

(51) Int. Cl. G02B 6/32; G02B 1/04; G02B 6/12; G02B 1/11

(52) U.S. Cl. CPC G02B 6/325; G02B 1/11; G02B 1/041; G02B 6/12; G02B 2006/12147

(57) ABSTRACT

An optical member is located between a first optical waveguide and a second optical waveguide, and guides light from the first optical waveguide to the second optical waveguide. The optical member includes a substrate, a lens, and a coating layer. The lens is located on the substrate, and is formed of energy-curable resin having a linear expansion coefficient of 70 ppm or less. The coating layer is formed to cover the lens, and prevents the reflection of light.

### TECHNICAL FIELD

The present invention relates to an optical member that is used to couple optical fibers used for optical communications and the like, and a coupling optical system including the optical member.

### BACKGROUND ART

The spread of mobile devices such as smartphones and tablets has created a need for data communication with a vast amount of information. Along with that, an increase is desired in the capacity of optical communications.

Conventional optical communications use a single-core fiber in which a core is encased in a cladding. However, when communication is performed with one single-core fiber, the capacity is so limited that there is a need for a technology to perform data communication with a capacity exceeding the limit.

In this regard, for example, a multi-core fiber can be used. The multi-core fiber is an optical fiber in which a plurality of cores is provided in one cladding (see Patent Documents 1 and 2). Because of having a plurality of cores, the multi-core fiber is capable of data communications with a higher capacity as compared to the single-core fiber.

In optical communications, these optical fibers are sometimes coupled together for use. In this case, if a coupling optical system is arranged between the optical fibers, the optical fibers can be optically coupled. The coupling optical system is formed of, for example, layers of a plurality of lenses.

Among the methods of creating the coupling optical system having layers of lenses is a wafer-level optics (WLO) technology. In WLO, a plurality of wafers, on which lenses are formed, are stacked in layers and diced into individual lens modules to create a plurality of coupling optical systems. The coupling optical systems created by WLO are used in, for example, a camera module as an imaging lens (see Patent Document 3).

### PRIOR ART DOCUMENT

### Patent Documents

[Patent Document 1] Japanese Unexamined Patent Application Publication No. Hei 10-104443

[Patent Document 2] Japanese Unexamined Patent Application Publication No. Hei 8-119656

[Patent Document 3] Japanese Unexamined Patent Application Publication No. 2009-98506

### SUMMARY OF THE INVENTION

### Problems to be Solved by the Invention

The storage environment of the coupling optical system used in optical communications is quite different from that of conventional coupling optical systems such as imaging lenses used in a camera module. Optical fibers used in optical communications may be exposed to a harsh storage environment. For example, after installation, the optical fibers used in optical communications are left in an environment of −40° C. to 75° C. without maintenance over nearly twenty years. Accordingly, the coupling optical system is exposed to a similar environment. Therefore, it is difficult to use such coupling optical systems (lens) as those created by conventional WLO.

Besides, it is important to secure the coupling efficiency (to reduce the coupling loss) for optically coupling optical fibers.

If the lens is provided with a coating layer for preventing reflection, the defect or deformation of the coating layer decreases the transmittance of the lens. The reduction in the transmittance of the lens causes a reduction in coupling efficiency upon coupling optical fibers using the optical coupling system including the lens.

The present invention is directed at solving the above problems, and the object is to provide an optical member that can withstand harsh storage environments and suppress a decrease in coupling efficiency when optical fibers are coupled, and a coupling optical system including the optical member.

### Means of Solving the Problems

To achieve the object mentioned above, an optical member as set forth in claim 1 is located between a first optical waveguide and a second optical waveguide, and guides light from the first optical waveguide to the second optical waveguide. The optical member includes a substrate, a lens, and a coating layer. The lens is located on the substrate, and is formed of energy-curable resin having a linear expansion coefficient of 70 ppm or less. The coating layer is formed to cover the lens, and prevents the reflection of light.

The optical member as set forth in claim 2 is the optical member of claim 1, wherein the lens includes a first lens and a second lens. The first lens is located on a first surface of the substrate. The second lens is located on a second surface on the back of the first surface in a position where the optical axis of the second lens matches the optical axis of the first lens. The coating layer is formed on both the first lens and the second lens.

The optical member as set forth in claim 3 is the optical member of claim 1 or 2, wherein the energy-curable resin is an epoxy resin.

The optical member as set forth in claim 4 is the optical member of claim 1 or 2, wherein the energy-curable resin is an acrylic resin.

The optical member as set forth in claim 5 is the optical member of claim 1 or 2, wherein the energy-curable resin is a mixture of a nanocomposite material and a silicone resin.

The optical member as set forth in claim 6 is the optical member of claim 3, wherein the energy-curable resin transmits light having a wavelength of 1.55 μm among wavelengths of the light.

A coupling optical system as set forth in claim 7 includes a plurality of optical systems and a spacer. The optical systems include the optical member of any one of claims 1 to 6. The spacer is located at least between the optical systems so that the optical systems are arranged in layers at predetermined intervals along the optical axis direction of lenses included in the optical systems.

### Effects of the Invention

As described above, the optical member of the present invention includes a lens that is formed of energy-curable resin having a linear expansion coefficient of 70 ppm or less. The lens is covered with a coating layer. With this, even in harsh storage environments, the lens is hardly deformed, and thus the coating layer is not likely to deform due to the deformation of the lens. Since deformation hardly occurs in the coating layer even in harsh storage environments, it is possible to reduce a decrease in coupling efficiency upon coupling optical fibers. That is, the optical member of the present invention can withstand harsh storage environments and suppress a decrease in coupling efficiency when optical fibers are coupled together.

### BRIEF DESCRIPTION OF THE DRAWINGS

FIG. 1 is a view of a multi-core fiber common in an embodiment.

FIG. 2 is a view of a coupling optical system according to the embodiment.

FIG. 3 is another view of the coupling optical system of the embodiment.

FIG. 4A is a view for explaining a method of manufacturing the coupling optical system of the embodiment.

FIG. 4B is another view for explaining the method of manufacturing the coupling optical system of the embodiment.

### MODES FOR CARRYING OUT THE INVENTION

### [Structure of Multi-Core Fiber]

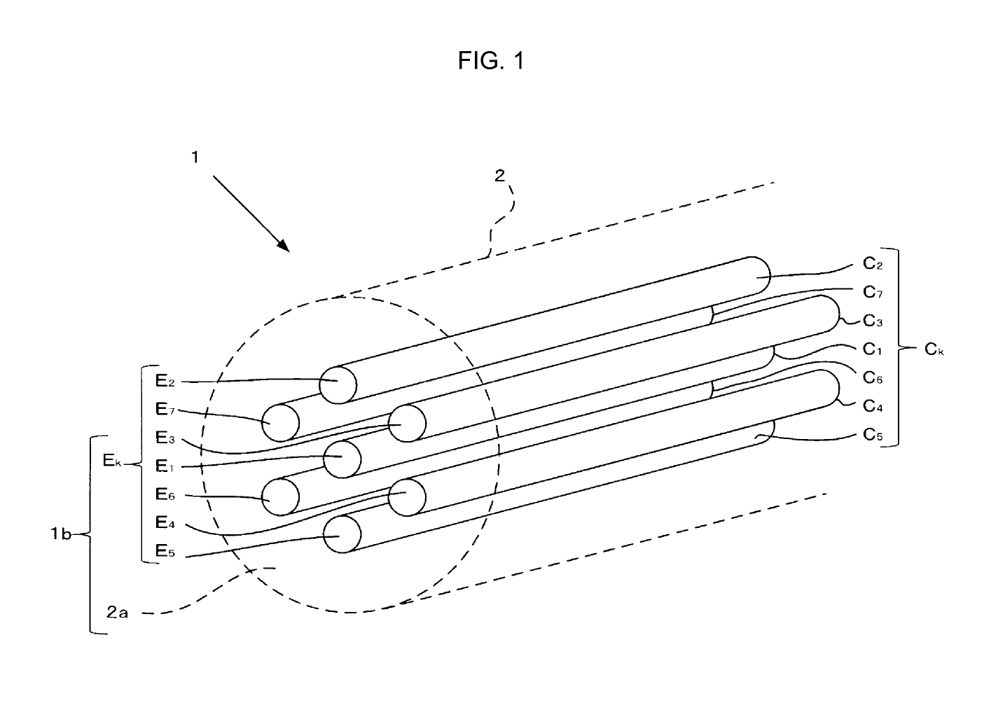

Referring to FIG. 1, a description is given of the structure of a multi-core fiber 1 according to an embodiment. The multi-core fiber 1 is generally a flexible elongated cylindrical member. FIG. 1 is a perspective view of the multi-core fiber 1, in which only the tip of the multi-core fiber 1 is illustrated.

The multi-core fiber 1 is formed of a material with high light transmissivity such as quartz glass, plastic, and the like. The multi-core fiber 1 includes a plurality of cores Cₖ (k=1 to n) and a cladding 2.

The cores Cₖ are transmission lines (optical paths) for transmitting light from a light source (not illustrated). Each of the cores Cₖ has an end surface Eₖ (k=1 to n). The end surface Eₖ radiates the light emitted from the light source (not illustrated). To achieve a higher refractive index than that of the cladding 2, for example, the cores Cₖ are formed of a material obtained by adding germanium oxide (GeO₂) to silica glass. Although FIG. 1 illustrates a structure including seven cores C₁ to C₇, at least two cores Cₖ may be sufficient.

The cladding 2 is a member that covers the cores Cₖ. The cladding 2 has a function of confining the light from the light source (not illustrated) in the cores Cₖ. The cladding 2 has an end surface 2a. The end surface 2a of the cladding 2 and the end surfaces Eₖ of the cores Cₖ form the same plane (an end surface 1b of the multi-core fiber 1). The cladding 2 is made of a material having a lower refractive index than that of the material of the cores Cₖ. For example, when the cores Cₖ are made of quartz glass and germanium oxide, quartz glass is used as a material for the cladding 2. In this manner, by providing the cores Cₖ with a higher refractive index than that of the cladding 2, the light from the light source (not illustrated) is totally reflected at the boundary surface between the cladding 2 and the cores Cₖ. With this, the light can be transmitted in the cores Cₖ.

### [Structure of Coupling Optical System]

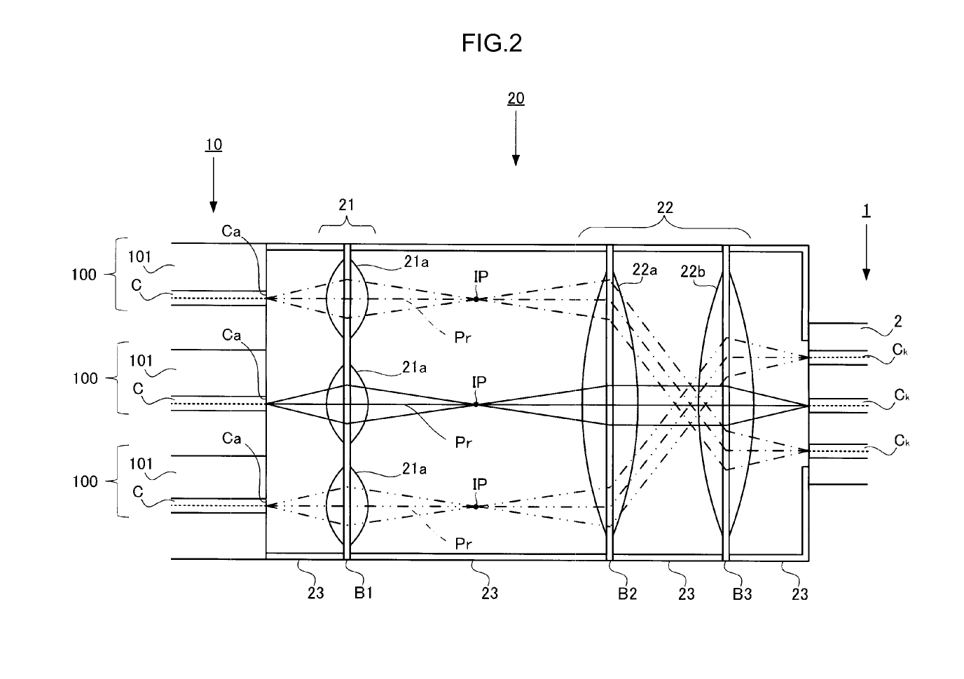

Next, a description is given of the structure of a coupling optical system 20 of the embodiment with reference to FIG. 2. The coupling optical system 20 is located between a first optical waveguide and a second optical waveguide, and guides the light from the first optical waveguide to the second optical waveguide. This embodiment describes an example of using a fiber bundle 10 formed of a bundle of a plurality of optical fibers each including a core covered with a cladding as the first optical waveguide, and the multi-core fiber 1 as the second optical waveguide. FIG. 2 is a conceptual diagram illustrating an axial cross-section of the coupling optical system 20, the fiber bundle 10, and the multi-core fiber 1.

The fiber bundle 10 includes a plurality of single-core fibers 100. The fiber bundle 10 is formed of a bundle of as many of the single-core fibers 100 as cores in the multi-core fiber 1 (seven in this embodiment) to be coupled with. FIG. 2 illustrates only three of the single-core fibers 100. The single-core fibers 100 each include a core C encased in a cladding 101. The core C is a transmission line for transmitting the light from the light source (not illustrated). The light emitted from an end surface Ca of the core C is incident to one end of the coupling optical system 20.

The coupling optical system 20 of the embodiment has the one end in contact with the fiber bundle 10 and the other end in contact with the multi-core fiber 1. The coupling optical system 20 includes a plurality of optical systems (a first optical system 21, a second optical system 22) and a spacer 23.

The first optical system 21 changes the mode field diameter of light received from each of the single-core fibers 100 so that the light is incident to the second optical system 22. The second optical system 22 changes the interval of the light received from the first optical system 21 to match the interval with the interval of the cores Cₖ of the multi-core fiber 1.

The first optical system 21 of the embodiment is an enlarged optical system that enlarges the mode field diameter of the light from each of the single-core fibers 100 of the fiber bundle 10. The first optical system 21 includes a plurality of convex lens units 21a that are arranged in an array.

The convex lens units 21a are arranged so that the optical axis coincides with both surfaces (a first surface and a second surface on back thereof) of a substrate B1, which is formed of glass or the like. That is, each of the convex lens units 21a is formed of a pair of convex lenses. The convex lens units 21a are provided as many as the single-core fibers 100 included in the fiber bundle 10 (seven in the embodiment) to guide every light from the fiber bundle 10. The first optical system 21 (the convex lens units 21a) is located at a position where a principal ray Pr of light emitted from each of the end surfaces Ca of the fiber bundle 10 is vertically incident to the surface of corresponding one of the convex lens units 21a (the convex lens units 21a are each located on the same optical axis as corresponding one of the cores C). The convex lens units 21a have a diameter larger than the mode field diameter of the cores C, and collect light from the cores C. The first optical system 21 of the embodiment is an example of “optical system”. In addition, each of the convex lens units 21a and the substrate B1 of the embodiment are an example of “optical member”.

The second optical system 22 of the embodiment is a reduction optical system that narrows the interval of light from the first optical system 21 (a plurality of light rays the mode field diameter of which has been enlarged), and guides the light to the cores C₁ to C₇ of the multi-core fiber 1. The second optical system 22 is formed of a both-side telecentric optical system including two convex lens units (a convex lens unit 22a, a convex lens unit 22b).

The convex lens unit 22a is arranged so that the optical axis coincides with both surfaces (a first surface and a second surface on back thereof) of a substrate B2, which is formed of glass or the like. That is, the convex lens unit 22a is formed of a pair of convex lenses. The convex lens unit 22b is arranged so that the optical axis coincides with both surfaces (a first surface and a second surface on back thereof) of a substrate B3, which is formed of glass or the like. That is, the convex lens unit 22b is formed of a pair of convex lenses.

The convex lens units 22a and 22b are provided one each to change the interval of light from a plurality of the convex lens units 21a. The second optical system 22 is located at such a position that the principal ray Pr of each light from the first optical system 21 is vertically incident to the end surface Eₖ of corresponding one of the cores Cₖ of the multi-core fiber 1. The second optical system 22 of the embodiment is an example of “optical system”. In addition, the convex lens unit 22a and the substrate B2 of the embodiment are an example of “optical member”. The convex lens unit 22b and the substrate B3 of the embodiment are another example of “optical member”.

The spacer 23 is located at least between a plurality of optical systems so that the optical systems are arranged in layers at predetermined intervals along the optical axis directions of lenses included in the optical systems. For example, the spacer 23 is formed of a resin material or glass. The spacer 23 and the optical systems are secured by an adhesive or the like.

In the embodiment, the spacer 23 is arranged between the first optical system 21 and the second optical system 22. The spacer 23 is arranged so that the first optical system 21 and the second optical system 22 are arranged in layers along the optical axis direction of the convex lens units 21a included in the first optical system 21 as well as along the optical axis direction of the convex lens unit 22a and the convex lens unit 22b included in the second optical system 22. Besides, in the embodiment, the spacer 23 is also provided between the first optical system 21 and the fiber bundle 10, between the convex lens unit 22a and the convex lens unit 22b, and between the second optical system 22 and the multi-core fiber 1.

The coupling optical system 20 and the fiber bundle 10 (the multi-core fiber 1) are secured together with an adhesive or the like. Alternatively, the coupling optical system 20 and the fiber bundle 10 (the multi-core fiber 1) may be releasably secured by a connector or the like.

### [Travel of Light]

In the following, a description is given of how the light travels in the embodiment with reference to FIG. 2. In the embodiment, an example is described in which light is emitted from the fiber bundle 10.

First, light is emitted from the end surface Ca of the core C provided in each of the single-core fibers 100. The light emitted from the end surface Ca is incident to corresponding one of the convex lens units 21a with a predetermined mode field diameter. As described above, in the embodiment, the principal ray Pr of the light emitted from the end surface Ca is vertically incident to each of the convex lens units 21a. Light passing through each of the convex lens units 21a forms an image at a focal point IP as having an enlarged mode field diameter.

The light passing through each of the convex lens units 21a is incident to the convex lens unit 22a using the focal point IP as a secondary light source.

The convex lens unit 22a and the convex lens unit 22b are formed as a both-side telecentric optical system. Accordingly, the principal ray Pr of the light vertically incident to the convex lens unit 22a passes therethrough while being collimated, and incident to the convex lens unit 22b. The principal rays Pr of the light are emitted vertically from the convex lens unit 22b at narrowed intervals, and vertically incident to the cores Cₖ of the multi-core fiber 1. Thus, with a plurality of optical systems arranged in layers, light can be concentrated and guided even between optical fibers having different diameters between the fiber bundle 10 and the multi-core fiber 1.

The first optical waveguide and the second optical waveguide are not limited to the above examples. For example, the multi-core fiber 1 may be used as the first optical waveguide, while the fiber bundle 10 may be used as the second optical waveguide. Alternatively, the multi-core fiber 1 may be used as both the first optical waveguide and the second optical waveguide. In this case, since it is not necessary to focus light from the first optical waveguide (the second waveguide), a plurality of optical systems are not required. In other words, at least one optical system is sufficient.

### [Structure of Optical Member]

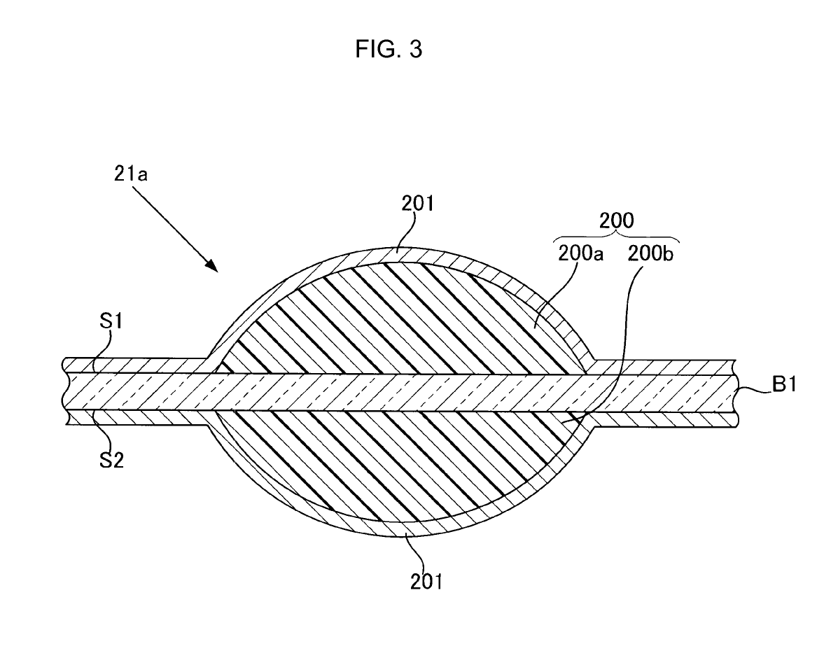

Next, referring to FIG. 3, a description is given of the detailed structure of the optical member according to the embodiment. All the convex lens units 21a of the first optical system 21 and the convex lens units 22a and 22b of the second optical system 22 are of the similar structure, and thus, one of the convex lens units 21a is taken as an example to be described below.

The convex lens unit 21a includes a lens 200 and a coating layer 201.

The lens 200 is arranged on the light-transmissive substrate B1. In the embodiment, the lens 200 includes a lens located on a first surface S1 of the substrate B1 (a first lens 200a), a lens located on a second surface S2 on the back of the first surface S1 (a second lens 200b) in a position where an optical axis thereof matches that of the first lens 200a. The first lens 200a (the second lens 200b) is arranged on the substrate B1 such that the optical axis thereof is perpendicular to the first surface S1 (the second surface S2).

The lens 200 (the first lens 200a and the second lens 200b) is formed of energy-curable resin having a linear expansion coefficient of 70 ppm or less. The energy-curable resin is a material that is generally liquid but solidifies when external energy (light, heat, etc.) is applied thereto. Incidentally, the linear expansion coefficient of the resin material is usually about 30 ppm or more. Therefore, the linear expansion coefficient of the energy-curable resin used in the embodiment is in practice around 30 ppm to 70 ppm.

By fabricating the lens 200 with a resin having a linear expansion coefficient of 70 ppm or less, deformation is less likely to occur in the lens 200 even in a harsh storage environment (e.g., for twenty years at a temperature of −40° C. to 75° C.). Accordingly, the optical member including the lens 200 (the coupling optical system 20 including the optical element) can be used for a long time without maintenance and the like.

Specific examples of usable energy-curable resin include a mixture of a nanocomposite material and silicone resin, acrylic resin, and epoxy resin.

The epoxy resin has an epoxy group, and is cured by external energy. Because of its low curing shrinkage rate, the epoxy resin is cured by external energy applied thereto along the shape of the mold. Thus, with the use of the epoxy resin, the lens 200 is molded with high accuracy.

A specific example of usable resin is a bisphenol-A epoxy resin with an epoxy equivalent of 200 g/eq or less according to JIS K7126 (i.e., a resin having a large molecular weight). The epoxy resin may be classified into, for example, glycidyl ether type, glycidyl amine type, glycidyl ester type. As an example of the epoxy resin may be cited bifunctional bisphenol-A glycidyl ether epoxy resin having repeat units. The epoxy resin may also be multifunctional cresol novolac epoxy resin having repeat units.

The acrylic resin is a polymer of methacrylic acid esters or acrylic acid ester, and is cured by external energy. The acrylic resin has high transparency. Accordingly, the lens 200 formed of acrylic resin can reduce coupling loss in the transmission of light. Further, Because of its high curing shrinkage rate, the acrylic resin has excellent releasability from a mold. This facilitates the molding (demolding).

The silicone resin is a material having high transparency as well as being excellent in heat resistance. On the other hand, due to its high linear expansion coefficient of 150 ppm to 300 ppm, the silicone resin cannot be used as the material of the lens 200 of the embodiment as it is. Therefore, in the embodiment, a mixture of a nanocomposite material and the silicone resin is used for the material of the lens 200. As the nanocomposite material, for example, silica-based particles may be used. For example, by mixing 50 wt % of silica-based particles with the silicone resin, a mixture having a linear expansion coefficient of about 70 ppm can be obtained.

Additionally, it is preferable to use a resin that enhances the transmission of wavelength used for optical communications to form the lens 200.

For example, when light having a wavelength of 1.55 μm is used for communication, it is preferable to use such a resin as causing less coupling loss of light in the band. For this reason, among epoxy resins having C—H bonds, a resin that is at least partially fluorinated is used. By the fluorination of C—H bonds, an absorption wavelength shift occurs. The use of a resin that is fluorinated in part can achieve the lens 200 capable of transmitting light having a wavelength of 1.55 μm at which coupling loss occurs in general epoxy resin. It is preferable to fluorinate all the C—H bonds of the epoxy resin except for aromatic C—H bonds. If aromatic C—H bonds are also fluorinated, absorption wavelength shifts increase. Besides, if the lens 200 is formed with epoxy resin in which aromatic C—H bonds are also fluorinated, the refractive index decreases. For example, C—H bonds other than aromatic C—H bonds are fluorinated (C—F bond) in bifunctional bisphenol-A glycidyl ether epoxy resin having repeat units. In this case, the fluorine content is about 30%. By performing the fluorination in this manner, a shift occurs in the appearance wavelength of harmonic absorption.

Incidentally, the first lens 200a and the second lens 200b may be formed of the above resin. The first lens 200a and the second lens 200b may be formed of the same resin, or may be formed of different resins.

The coating layer 201 is formed to cover the lens 200, and prevents reflection of light on the surface. In other words, the coating layer 201 can enhance the transmittance of light incident to the lens 200. Specifically, the coating layer 201 is formed on the surfaces of the lens 200 in contact with the air (the surfaces opposite to the substrate B1). The coating layer 201 may be formed on at least one of the first lens 200a and the second lens 200b. However, as illustrated in Example 1 below, it is preferable to provide the coating layer 201 to both the lenses (the first lens 200a and the second lens 200b).

The coating layer 201 includes, for example, layers of a mixture of Ta₂O₅ and 5% TiO₂, and layers of SiO₂, which are deposited alternately (e.g., seven layers). The coating layer 201 is not limited to this structure as long as being able to prevent the reflection of light. Incidentally, to increase the light transmittance, the thicker coating layer 201 is preferable. On the other hand, to improve the durability of the coating layer 201, the thinner one is preferable. Therefore, the thickness of the coating layer 201 can be arbitrarily set depending on the storage environment of the coupling optical system 20 (optical member), use conditions, and the like.

By providing the coating layer 201, it is possible to suppress the reflection of incident light and the like, thereby reducing the loss of light. That is, the coating layer 201 can reduce the decrease in coupling efficiency. In addition, as described above, the lens 200 of the embodiment is formed of a resin having a low linear expansion coefficient, and therefore is hardly deformed by environmental changes. Accordingly, the coating layer 201 provided to cover the lens 200 is less affected by the deformation of the lens 200. Thus, cracks, or the like, which cause the loss of light hardly occur. That is, the coupling optical system 20 (optical member) of the embodiment can maintain the coupling efficiency even in harsh storage environments.

### [Manufacturing Method of Coupling Optical System]

The coupling optical system 20 of the embodiment can be fabricated through a common WLO technology.

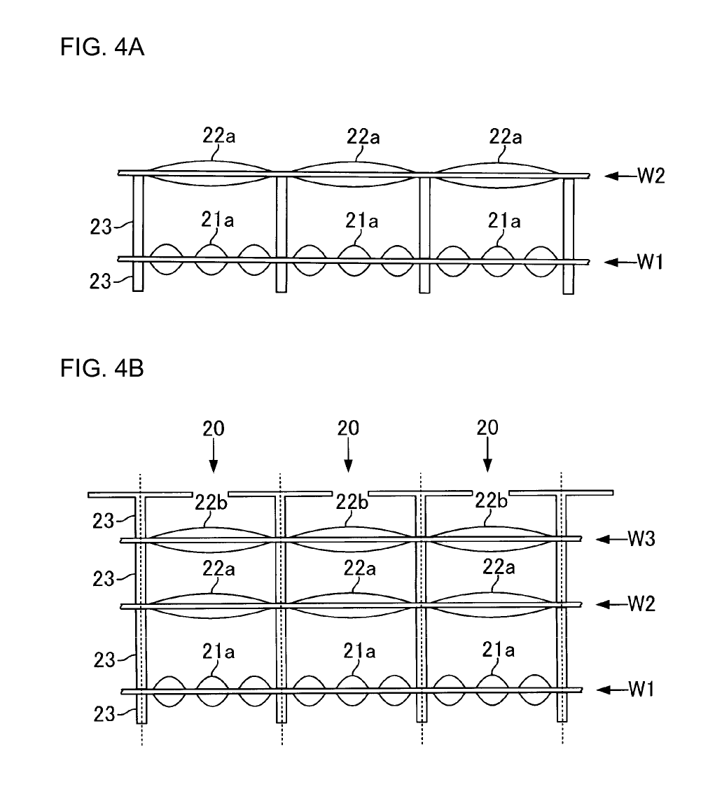

First, a wafer W1 on which a plurality of the convex lens units 21a is formed and a wafer W2 on which a plurality of the convex lens units 22a is formed are adhesively bonded together through the spacer 23 (see FIG. 4A). In the embodiment, the wafers W1 and W2 are bonded so that one of the convex lens units 22a faces seven of the convex lens units 21a (FIG. 4A illustrates only three of the convex lens units 21a). Further, among the surfaces of the wafer W1, the spacer 23 is bonded on the surface opposite to the surface facing the wafer W2.

Next, a wafer W3 on which a plurality of the convex lens units 22b is formed is bonded to the wafer W2 through the spacer 23 (see FIG. 4B). In the embodiment, the wafers W2 and W3 are bonded together so that one of the convex lens units 22a faces one of the convex lens units 22b.

The bonded lens wafers are then diced into individual lens modules (in FIG. 4B, broken lines indicate dicing positions). Thus, a plurality of the coupling optical system 20 can be created. Note that FIGS. 4A and 4B illustrate only a part of the wafers W1 to W3.

### EXAMPLES

Described below are specific examples of the embodiment.

### Example 1

Environmental tests and transmittance measurements were performed on optical members (the convex lens units 21a) each including the lens 200 formed of a resin having a predetermined linear expansion coefficient and the coating layer 201 formed thereon.

In a) of Example 1, the lens 200 was formed of a resin having a linear expansion coefficient of 40 ppm. In b) of Example 1, the lens 200 was formed of a resin having a linear expansion coefficient of 70 ppm. In c) of Example 1, the lens 200 was formed of a resin having a linear expansion coefficient of 80 ppm. In d) of Example 1, the lens 200 was formed of a resin having a linear expansion coefficient of 150 ppm. The same coating layer 201 was used in a) to d) of Example 1. The coating layer 201 included layers of a mixture of Ta₂O₅ and 5% TiO₂, and layers of SiO₂, which were deposited alternately (seven layers), and was formed on both the first lens 200a and the second lens 200b.

Environmental tests were conducted in accordance with the Telcordia standard. The above optical members were tested “at −40° C. for 30 minutes, and at 75° C. for 30 minutes” as one cycle which was repeated 500 times. Before and after the environmental tests, the optical members were observed by a microscope at 200 times magnification (VHX-2000, Keyence Corporation) to visually check the number of cracks.

The transmittance measurements were performed before and after the environmental tests. The optical members were measured by a spectrophotometer (Hitachi spectrophotometer U-4100, Hitachi High-Technologies Corporation). The transmittance was measured of light of 1550 nm.

### (Evaluation Criteria)

In Table 1, the number of cracks observed by the microscope at 200 times magnification is represented as follows: “∘” indicates no crack, “A” indicates the presence of cracks (10 or less), and “x” indicates the presence of cracks (11 or more).

TABLE 1

| | a) | b) | c) | d) |
|---|---|---|---|---|
| transmittance before environmental test | 98% | 98% | 98% | 98% |
| cracks before environmental test | ∘ | ∘ | ∘ | ∘ |
| transmittance after environmental test | 98% | 98% | 97% | 96% |
| cracks after environmental test | ∘ | ∘ | Δ | x |

### Analysis of Example 1

As can be seen from a) to d) of Example 1, before the environmental tests, no significant difference was observed in transmittance. In addition, there was no crack in every case.

In a) and b) of Example 1, no change was observed in the number of cracks even after the environmental tests. A possible reason of this is that because of being formed of a resin having a low linear expansion coefficient, the lens 200 was hardly deformed by environmental changes, and thus, deformation was unlikely to occur also in the coating layer 201. Besides, in a) and b) of Example 1, no change was observed in transmittance even after the environmental tests. This is believed to be due to the fact that because no crack occurred in the coating layer 201, the performance of the coating layer 201 was maintained.

On the other hand, in c) of Example 1, the transmittance was reduced after the environmental tests, and a few cracks were observed. A possible reason of this is that because of being formed of a resin having a high linear expansion coefficient, the lens 200 could not withstand environmental changes and was deformed, and thus, deformation also occurred in the coating layer 201. In addition, it is also assumed that due to the cracks generated in the coating layer 201, the transmittance of the optical member was reduced.

In d) of Example 1, the transmittance was further reduced after the environmental tests as compared to c) of Example 1, and cracks occurred significantly. As is apparent from c) and d) of Example 1, as the linear expansion coefficient becomes higher, the number of cracks increases, and the transmittance of the optical member is reduced due to the cracks.

### Example 2

Transmittance measurements were performed on the lens 200 formed of a resin having the same linear expansion coefficient with and without the coating layer 201.

In e) to g) of Example 2, the lens 200 was formed of a resin having a linear expansion coefficient of 70 ppm. The coating layer 201 included layers of a mixture of Ta₂O₅ and 5% TiO₂, and layers of SiO₂, which were deposited alternately (seven layers). In e) of Example 2, the coating layer 201 was not provided. In f) of Example 2, the coating layer 201 was provided to either one of the lenses (e.g., the first lens 200a). In g) of Example 2, the coating layer 201 was formed on both the lenses (e.g., the first lens 200a and the second lens 200b).

In the transmittance measurements, as in Example 1, the optical members were measured by a spectrophotometer (Hitachi spectrophotometer U-4100, Hitachi High-Technologies Corporation). The transmittance was measured of light of 1550 nm.

TABLE 2

| | transmittance |
|---|---|
| e) no coating layer | 90% |
| f) coating layer on one side | 94% |
| g) coating layer on both sides | 98% |

∘

### Analysis of Example 2

From the results of e), f), and g) of Example 2, it was found that higher transmittance was achieved when the coating layer 201 was provided to the lens 200.

This is believed to be due to the fact the coating layer 201 prevents reflection on the lens 200, which reduces the loss of incident light.

Further, from the results of f) and g) of Example 2, it was found that when there were lenses on both sides, higher transmittance was achieved by providing the coating layer 201 to both the lenses.

When light passes through both the lenses (it is assumed herein that light enters from the first lens 200a side), light reflection occurs on the light incident surface (the optical surface of the first lens 200a) as well as the light emitting surface (the optical surface of the second lens 200b). Therefore, if the coating layer 201 is formed on both the lenses, better reduction of light loss can be achieved. For these reasons, the above effects can be obtained.

### EXPLANATION OF SYMBOLS

1 Multi-core fiber
1b End surface
2 Cladding
2a End surface
10 Fiber bundle
20 Coupling optical system
21 First optical system
21a Convex lens unit
22 Second optical system
22a, 22b Convex lens unit
100 Single-core fiber
101 Cladding
200 Lens
200a First lens
200b Second lens
201 Coating layer
C, Cₖ Core
Ca, Eₖ End surface

1. An optical member located between a first optical waveguide and a second optical waveguide to guide light from the first optical waveguide to the second optical waveguide, the optical member comprising:
a substrate;
a lens on the substrate, the lens being formed of energy-curable resin having a linear expansion coefficient of 70 ppm or less; and
a coating layer formed to cover the lens and prevent reflection of the light.

2. The optical member according to claim 1, wherein
the lens includes a first lens located on a first surface of the substrate, and a second lens located on a second surface on back of the first surface in a position where an optical axis of the second lens matches an optical axis of the first lens, and
the coating layer is formed on both the first lens and the second lens.

3. The optical member according to claim 1, wherein the energy-curable resin is an epoxy resin.

4. The optical member according to claim 1, wherein the energy-curable resin is an acrylic resin.

5. The optical member according to claim 1, wherein the energy-curable resin is a mixture of a nanocomposite material and a silicone resin.

6. The optical member according to claim 3, wherein the energy-curable resin transmits light having a wavelength of 1.55 μm among wavelengths of the light.

7. A coupling optical system, comprising:
a plurality of optical systems including the optical member according to claim 1; and
a spacer located at least between the optical systems so that the optical systems are arranged in layers at predetermined intervals along optical axis directions of lenses included in the optical systems.
